(19) United States
(12) Patent Application Publication
(10) Pub. No.: US 2017/0212867 A1
(43) Pub. Date: Jul. 27, 2017

(54) METHOD FOR COMPUTING SPHERICAL CONFORMAL AND RIEMANN MAPPING

(71) Applicant: SHING-TUNG YAU, CAMBRIDGE, MA (US)

(72) Inventors: WEI-QIANG HUANG, KAOHSIUNG CITY (TW); TSUNG-MING HUANG, YUNLIN COUNTY (TW); WEN-WEI LIN, TAIPEI CITY (TW); SONG-SUN LIN, HSINCHU CITY (TW); XIANFENG DAVID GU, PLAINVIEW, NY (US); SHING-TUNG YAU, CAMBRIDGE, MA (US)

(21) Appl. No.: 15/007,499

(22) Filed: Jan. 27, 2016

(51) Int. Cl. G06F 17/13

(52) U.S. Cl. CPC G06F 17/13

(57) ABSTRACT

A classical way of finding the harmonic map is to minimize the harmonic energy by the time evolution of the solution of a nonlinear heat diffusion equation. To arrive at the desired harmonic map, which is a steady state of this equation, an efficient quasi-implicit Euler method (QIEM) is revealed and its convergence under some simplifications is analyzed. It is difficult to find the stability region of the time steps if the initial map is not close to the steady state solution. A two-phase approach for the quasi-implicit Euler method (QIEM) is disclosed to overcome this drawback. In order to accelerate the convergence, a variant time step scheme and a heuristic method used to determine an initial time step have been developed. Numerical results clearly demonstrate that the present method far computing the spherical conformal and Riemnann mappings achieves high performance.

### BACKGROUND OF THE INVENTION

Field of the Invention

The present invention relates to a computing method, especially to a method for computing spherical conformal and Riemann mappings applied to brain mapping, surface classification and global surface parameterizations.

Descriptions of Related Art

Conformal surface parameterizations have been studied intensively, and most works deal with genus zero surfaces. The basic approaches are harmonic energy minimization, Cauchy-Riemann equation approximation, Laplacian operator linearization, angle-based flattening method and circle packing, among others. In harmonic energy minimization, a discrete harmonic map is introduced to approximate the continuous harmonic map by minimizing a metric dispersion criterion. Due to the conformal nature of harmonic maps from a genus zero closed surface to the unit sphere, Gu and Yau et. al proposed a nonlinear optimization method for genus zero closed surface by minimizing the harmonic energy iteratively on the unit sphere until convergence to a harmonic map. The method has been applied to brain mapping, surface classification and global surface parameterizations.

The evolution of computing a conformal map f from genus zero closed surfaces to the unit sphere is carried out by a nonlinear heat diffusion equation:

$$\frac{df}{dt} = - Δ f , \qquad ( 1 )$$

with f to be constrained on the unit sphere. The explicit (forward) Euler method has been used to produce a steady-state solution of the nonlinear heat diffusion equation (1) in some researches. The explicit scheme is attractive for its simplicity. Unfortunately, it is known to have a small stability region that leads to extremely small time steps. While the implicit (backward) Euler method has a much larger stability region, it involves nonlinear systems. In this step, it is crucial to have a successful iterative method and a good way to produce the associated initial guess when the time step is relatively large. To tackle this challenging problem, the semi-implicit Euler methods have been proposed to simplify the nonlinearity of the systems and improve the computational cost in each iteration.

### SUMMARY OF THE INVENTION

Therefore it is a primary object of the present invention to provide a method for computing spherical conformal and Riemann mappings that solves a nonlinear heat diffusion equation by a two-phase approach for the underlying quasi-implicit Euler method (QIEM). Phase-I QIEM is used to quickly find an approximate solution which is close to the steady state solution. Then Phase-II QIEM is applied to compute the steady state solution using the approximate solution produced by Phase-I QIEM. The advantages of the two-phase QIEM are that it only needs to solve a linear system and allows a large time step in each iteration. For the iterative methods of solving the steady state ordinary differential equation (ODE) systems, the adaptive methods for controlling the time step in each iteration are proposed to accelerate its convergence. The present invention not only uses a heuristic method to estimate the initial time step but also develops an adaptive method to control the time step so that the two-phase QIEM possesses high performance. Promising numerical results illustrate the efficiency and stability of the present method.

In order to achieve the above objects, a method for computing spherical conformal and Riemann mappings according to the present invention includes the following steps. First carry out evolution of computing a conformal map f from a genus zero closed surface to the unit sphere (the spherical conformal mapping) as well as from a simply connected surface with a single boundary to a 2D disk (the Riemann mapping) by a nonlinear heat diffusion equation. Then solve the nonlinear heat diffusion equation by a quasi-implicit Euler method (QIEM). Next analyze convergence of the QIEM under some simplifications. Lastly accelerate the convergence of the QIEM by using a two-phase approach for the quasi-implicit Euler method to estimate an initial time step and an adaptive method to control the time step.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1a is one example of a facial expression for a person according to one embodiment of the present invention illustrating the sample case of a neutral facial expression;

FIG. 1b is one example of a facial expression for a person according to one embodiment of the present invention illustrating the sample case of a smile facial expression;

FIG. 1c is one example of a facial expression for a person according to one embodiment of the present invention illustrating the sample case of a sad facial expression;

FIG. 1d is one example of a facial expression for a person according to one embodiment of the present invention illustrating the sample case of a pout facial expression;

FIG. 1e is one example of a facial expression for a person according to one embodiment of the present invention illustrating the sample case of a bitter smile facial expression;

FIG. 1f is one example of a facial expression for a person according to one embodiment of the present invention illustrating the sample case of a pain facial expression;

FIG. 1g is one example of a facial expression for a person according to one embodiment of the present invention illustrating the sample case of a wry facial expression;

FIG. 1h is one example of a facial expression for a person according to one embodiment of the present invention illustrating the sample case of a ferocious facial expression;

FIG. 2a is one example of a closed surface according to one embodiment of the present invention illustrating the sample case of a bimba closed surface;

FIG. 2b is one example of a closed surface according to one embodiment of the present invention illustrating the sample case of a cortex closed surface;

FIG. 2c is one example of a closed surface according to one embodiment of the present invention illustrating the sample case of a torso closed surface;

FIG. 2d is one example of a closed surface according to one embodiment of the present invention illustrating the sample case of a horse closed surface;

FIG. 3a shows convergence behavior of the computed harmonic energy produced by an explicit Euler method according to one exemplary embodiment of the present invention;

FIG. 3b shows convergence behavior of the computed harmonic energy produced by an implicit Euler method according to one exemplary embodiment of the present invention;

FIG. 3c shows convergence behavior of the computed harmonic energy produced by a quasi-implicit Euler method according to one exemplary embodiment of the present invention;

FIG. 4a shows convergence behavior of the computed harmonic energy produced by the phase-II quasi-implicit Euler method with an initial time step δt0 of 1 according to one exemplary embodiment of the present invention;

FIG. 4b shows convergence behavior of the computed harmonic energy produced by the phase-II quasi-implicit Euler method with an initial time step δt0 of 10 according to one exemplary embodiment of the present invention;

FIG. 4c shows convergence behavior of the computed harmonic energy produced by the phase-II quasi-implicit Euler method with an initial time step δt0 of 100 according to one exemplary embodiment of the present invention;

FIG. 4d shows convergence behavior of the computed harmonic energy produced by the phase-II quasi-implicit Euler method with an initial time step δt0 of 1000 according to one exemplary embodiment of the present invention;

FIG. 5a shows a human hand;

FIG. 5b shows the computed harmonic energies for various iterations of phase-II QIEM for the human hand according to one exemplary embodiment of the present invention;

FIG. 5c shows the computed time steps for various iterations of phase-II QIEM for the human hand according to one exemplary embodiment of the present invention;

FIG. 6a shows the computed harmonic energies for various iterations of the two-phase QIEM for the human torso in FIG. 2c;

FIG. 6b shows the computed time steps for various iterations of the two-phase QIEM for the human torso in FIG. 2c.

### DETAILED DESCRIPTION OF THE PREFERRED EMBODIMENT

In order to learn functions and features of the present invention, please refer to the following embodiments with detailed descriptions and the figures.

### Conformal Mappings

### Spherical Conformal Mapping

First the spherical conformal mapping for genus zero closed surfaces from the point of view that a map is conformal if and only if it is harmonic is introduced. That means how to use the heat flow method to deform a mapping into the harmonic mapping under a special normalization condition is also introduced.
Suppose M is a triangular mesh of a genus zero closed surface with n vertices {v1, . . . , vn}. All piecewise linear functions defined on M is denoted by C^{PL}(M), which forms a linear space.
Definition 1. (Discrete harmonic energy). Let f=(f₁, f₂, f₃): M→ [symbol] ³ with f f₁, f₂, f₃ ∈ C^{PL}(M). The harmonic energy of f is defined as

$$\begin{matrix}{ɛ}_{h} ( f ) = {\sum }_{l = 1}^{3} {ɛ}_{h} ( {f}_{l} ) & ( 2 a ) \\ with & \\ {ɛ}_{h} ( {f}_{l} ) = \frac{1}{2} {\sum }_{[ {v}_{i} , {v}_{j} ] ∈ M} {{k}_{ij} ( {f}_{l} ( {v}_{i} ) - {f}_{l} ( {v}_{j} ) )}^{2} , l = 1 , 2 , 3 , & ( 2 b )\end{matrix}$$

where {kᵢⱼ} forms a set of harmonic weights assigned on each edge [vᵢ, vⱼ] ∈ M and is chosen such that the quadratic form of (2b) is positive definite.
Definition 2. Let f=(f₁, f₂, f₃): M→ [symbol] ³ with f f₁, f₂, f₃ ∈ C^{PL}(M). The piecewise Laplacian operator off is defined by

$$\begin{matrix}{Δ}_{d} f = ( {Δ}_{d} {f}_{1} , {Δ}_{d} {f}_{2} , {Δ}_{d} {f}_{3} ) & ( 3 ) \\ with & \\ {Δ}_{d} {f}_{l} ( {v}_{i} ) = {\sum }_{[ {v}_{i} , {v}_{j} ] ∈ M} {k}_{ij} ( {f}_{l} ( {v}_{i} ) - {f}_{l} ( {v}_{j} ) ) , l = 1 , 2 , 3 , & \end{matrix}$$

in which kᵢⱼ are the harmonic weights in (2b).

Let f (v) and n(f(v)) denote the image of the vertex v ∈ M and the normal on the target plane at f(v), respectively. Then the normal and tangent components of Δ_{d}f are defined as

(Δ_{d}f(υ))^{⊥}=<Δ_{d}f(υ), n(f(υ))>n(f(υ)) (4)

and

(Δ_{d}f(υ))^{∥}=Δ_{d}f(υ)−(Δ_{d}f(υ))^{⊥}, (5)

respectively, where <•, •> denotes the inner product in [symbol] ³. Moreover, a map f: M₁→M₂ is harmonic, if and only if f only has a normal component, and the tangential component is zero, i.e.,

Δ_{d}f=(Δ_{d}f)^{⊥}. (6)
Remark 1. Note that if the following is taken

$${a}_{ii} := {\sum }_{[ {v}_{i} , {v}_{j} ] ∈ M} {k}_{i , j} , {a}_{ij} := - {k}_{ij} , i \neq j , \qquad ( 7 )$$

for i, j=1, n and define A≡[aᵢⱼ] ∈ [symbol] ^{n×n}, then the discrete Laplacian operator Δ_{d}f in (2) can be represented as the matrix form

Δ_{d}f=Af=(Af₁,Af₂,Af₃). (8)

Many different ways are proposed to determine the edge weights kᵢⱼ in (2) so that the associated coefficient matrix A in (7) is symmetric positive semi-definite. A widely used edge weighting is the cotangent weighting. The matrix A associated with cotangent weights has been shown to be symmetric positive semi-definite.

A classical way to find the harmonic map f: M→ [symbol] ² is to minimize the discrete harmonic energy (2) by time evolution according to the nonlinear heat diffusion process

$$\frac{df}{dt} = - {Δ}_{d} f . \qquad ( 9 )$$

However, f(M, t) is constrained on the unit sphere [symbol] ² so that it needs to project −Δ_{d}f onto the tangent plane of the sphere. Therefore, from (4)-(6), the evolution of f is according to the nonlinear heat diffusion equation:

$$\frac{df ( v )}{dt} = - {( {Δ}_{d} f ( v ) )}^{‖} = - ( {Δ}_{d} f ( v ) - 〈 {Δ}_{d} f ( v ) , n ( f ( v ) ) 〉 n ( f ( v ) ) ) . \qquad ( 10 )$$

One major difficulty is that the solution to the conformal mapping from M to [symbol] ² is not unique but forms a Möbius group. In order to determine a unique solution, the additional zero mass-center constraint is required.
Definition 3. A mapping f: M₁→M₂ satisfies the zero mass-center condition if and only if

∫_{M}_{₁}fdσ_{M}_{₁}=0,

where dσ_{M1} is the area element on M₁. All conformal maps from M to [symbol] ² satisfying the zero mass-center constraint are unique up to the Euclidean rotation group.

### Riemann Mapping

The spherical conformal mapping for genus zero closed surfaces can be utilized to find a conformal mapping (Riemann mapping) from a simply connected surface M with a single boundary ∂M to a two-dimensional (2D) unit disk [symbol] . The procedures for finding Riemann mapping are stated as follows. For a given simply connected triangular mesh M with boundary ∂M, there exists a symmetric closed surface Mc, called a double covering of M, which covers M twice, i.e., for each face in M, there are two preimages in Mc. Applying the spherical conformal mapping to Mc, a conformal map from Mc to the unit sphere [symbol] ² is found. Next, a Möbius transformation τ: [symbol] →

[symbol]

$$τ ( z ) = \frac{az + b}{cz + d} , a , b , c , d ∈ ℂ , ad - bc = 1 ,$$

is used to adjust the conformal map such that ∂M is mapped to the equator of the unit sphere. Finally, the stereographic projection φ: [symbol] ²→

[symbol]

$$φ ( x , y , z ) = ( \frac{x}{1 - z} , \frac{y}{1 - z} ) , ( x , y , z ) ∈ {𝕊}^{2}$$

is applied to map the lower hemisphere conformally to the unit disk [symbol] .

### Quasi-Implicit Euler Method

Solving the steady state problems in (10) is the most time consuming step in finding conformal mappings. Thus an efficient algorithm is provided to solve (10).

The following definition is given for convenience.
Definition 1. Given

$$u ≡ [ \begin{matrix}{u}_{1} \\ ⋮ \\ {u}_{n}\end{matrix} ] ∈ {ℝ}^{n \times 3} , v ≡ [ \begin{matrix}{v}_{1} \\ ⋮ \\ {v}_{n}\end{matrix} ] ∈ {ℝ}^{n \times 3} ,$$

the operator [symbol] u, v [symbol] is denoted as

[symbol]

u, v [symbol] =diag(u₁v₁^{T}, . . . , uₙvₙ^{T}).

### Explicit and Implicit Euler Methods

For solving the steady state problem in (10), an explicit (forward) Euler method has been proposed by the following updating

$$\begin{matrix}\frac{{f}^{( m + 1 )} - {f}^{( m )}}{δ t} = - ( {Δ}_{d} {f}^{( m )} - ≺ {Δ}_{d} {f}^{( m )} , {f}^{( m )} ≻ {f}^{( m )} ) \\ = - ( A - ≺ A {f}^{( m )} , {f}^{( m )} ≻ ) {f}^{( m )} .\end{matrix}$$

Here the matrix A is the coefficient matrix of the Laplacian operator as in (7) with the edge weights kᵢⱼ. The advantage of the explicit Euler method is that it only needs matrix-vector multiplications in each iteration. By choosing time step δt carefully, the associated energy can be monotonically diminished at each iteration, for example, when δt is chosen close to the square of the minimum of the edge lengths of M. However, in order to ensure numerical stability, the explicit technique always requires a very small time step which results in a significant drawback—a very slow convergence rate.

To remedy this obstacle, one may apply the implicit (backward) Euler method, which is A-stable over a wide range of time steps, to solve (10) as follows:

$$\begin{matrix}\frac{{f}^{( m + 1 )} - {f}^{( m )}}{δ t} = - ( {Δ}_{d} {f}^{( m + 1 )} - ≺ {Δ}_{d} {f}^{( m + 1 )} , {f}^{( m + 1 )} ≻ {f}^{( m + 1 )} ) \\ = - ( A - ≺ A {f}^{( m + 1 )} , {f}^{( m + 1 )} ≻ ) {f}^{( m + 1 )} ,\end{matrix} \qquad ( 11 )$$

or equivalently,

[I+(δt)A]f^{(m+1)}−(δt) [symbol] Af^{(m+1)}, f^{(m+1)} [symbol] f^{(m+1)}=f^{(m)}.

The above equation may be rewritten as the nonlinear systems F(f^{(m+1)}, f^{(m)})=0, where

F(f^{(m+1)}, f^{(m)})≡−vec(f^{(m)})+{(I₃ [symbol] [I+(δt)A])−(δt)(I₃ [symbol] [symbol] Af^{(m+1)}, f^{(m+1)} [symbol] )}vec(f^{(m+1)}). (12)

The unknown vectors f^{(m+1)} of F(f^{(m+1)}, f^{(m)} ) can be solved by Newton's method

vec(fᵢ₊₁^{(m+1)})=vec(fᵢ^{(m+1)})−J(fᵢ^{(m+1)})⁻¹F(fᵢ^{(m+1)}, f^{(m)}) (13)

with f₀^{(m+1)}=f^{(m)}, where J (f^{(m+1)}) is the Jacobian matrix of F(f^{(m+1)}, f^{(m)}).

The implicit Euler method in (11) requires to solve a linear system if Newton's method is applied. Although the Jacobian matrix J (fᵢ^{(m+1)}) can be reordered as a banded matrix so that direct methods can be applied, its size is enlarged to three times that of the matrix A.

### Quasi-Implicit Euler Method

In order to avoid solving the nonlinear system in implicit Euler methods, some semi-implicit Euler methods have been proposed to improve the computational cost in each iteration. Based on these, the following quasi-implicit Euler method (QIEM) is proposed for solving the nonlinear heat diffusion equation in (10):

$$\begin{matrix}\frac{{f}^{( m + 1 )} - {f}^{( m )}}{δ t} = - ( {Δ}_{d} {f}^{( m + 1 )} - ≺ {Δ}_{d} {f}^{( m )} , {f}^{( m )} ≻ {f}^{( m + 1 )} ) \\ = - ( A - ≺ A {f}^{( m )} , {f}^{( m )} ≻ ) {f}^{( m + 1 )} .\end{matrix}$$

That is, in each iteration, the new vector f^{(m+1)} is generated by solving the linear system

[I+δt(A− [symbol] Af^{(m)}, f^{(m)} [symbol] )]f^{(m+1)}=f^{(m)}. (14)

As an implicit Euler method, the QIEM has a wider range of stable time steps. Moreover, QIEM is much more efficient than the implicit Euler method by comparing the computational costs of solving the linear systems in (13) and (14).

### Convergence Analysis of QIEM

In this section, the convergence of QIEM under the simplification of normalization of f^{(m+1)} is analyzed.

The QIEM with simplification of the normalization of f^{(m+1)} is stated as follows. Given f⁽⁰⁾ ∈ [symbol] ^{n×3} with

$${‖ {e}_{i}^{T} {f}^{( 0 )} ‖}_{2} = \frac{1}{\sqrt{n}}$$

for i=1, . . . , n, i.e., ∥f⁽⁰⁾∥_{F}=1, f^{(m+1)} is defined by

$${f}^{( m + 1 )} = \frac{1}{\sqrt{n}} {D}_{m}^{- 1 / 2} {A}_{m}^{- 1} {f}^{( m )} , \qquad ( 15 )$$

for m=0, 1, . . . , where

Aₘ=I+δt(A− [symbol] Af^{(m)}, f^{(m)} [symbol] ), (16)

Dₘ= [symbol] Aₘ⁻¹f^{(m)}, Aₘ⁻¹f^{(m)} [symbol] . (17)
Note that

$${‖ {e}_{i}^{T} {f}^{( m + 1 )} ‖}_{2} = \frac{1}{\sqrt{n}}$$

for i=1, . . . , n and ∥f^{(m+1)}∥_{F}=1.

Let us consider the Schur decomposition

QₘΛₘQₘ^{T}=A− [symbol] Af^{(m)}, f^{(m)} [symbol] , (18)

where Qₘ≡[_{q1,m, . . . , qn,m}]^{T} is orthonormal and Λₘ=diag(λ₁^{(m)}, . . . , λₙ^{(m)}) with λᵢ^{(m)} being the eigenvalues. It is assumed λᵢ^{(m)}≠0 for i=1, . . . , n. Then

$$\begin{matrix}\frac{1}{\sqrt{n}} {‖ {D}_{m}^{- 1 / 2} ‖}_{2} = \frac{1}{\sqrt{n}} {max}_{i} \{ {‖ {e}_{i}^{T} {A}_{m}^{- 1} {f}^{( m )} ‖}_{2}^{- 1} \} \\ = \frac{1}{\sqrt{n}} {max}_{i} \{ {‖ {{q}_{i , m}^{T} ( I + δ t {Λ}_{m} )}^{- 1} {Q}_{m}^{T} {f}^{( m )} ‖}_{2}^{- 1} \} \\ = \frac{δ t}{\sqrt{n}} {max}_{i} \{ {‖ {q}_{i , m}^{T} {Λ}_{m}^{- 1} {Q}_{m}^{T} {f}^{( m )} + {O}_{m} ( \frac{1}{δ t} ) ‖}_{2}^{- 1} \} ,\end{matrix} \qquad ( 19 )$$

where Om (1/δt) is dependent on (i,m). Given a small positive value ηₘ>0, there exists T₀>0 such that

$${‖ {O}_{m} ( \frac{1}{δ t} ) ‖}_{2} \leq {η}_{m} , ∀ δ t \geq {T}_{0} \qquad ( 20 )$$

which implies that

$$\frac{1}{\sqrt{n}} {‖ {D}_{m}^{- 1 / 2} ‖}_{2} \leq \frac{δ t}{\sqrt{n}} {max}_{i} \{ {‖ {\vert {q}_{i}^{T} {Λ}_{m}^{- 1} {Q}_{m}^{T} {f}^{( m )} ‖}_{2 - {η}_{m}} \vert}^{- 1} \} ≡ \frac{δ t}{\sqrt{n}} \frac{1}{{a}_{m}} . \qquad ( 21 )$$

By the definition of f^{(m+1)} in (15), it holds that

$$\begin{matrix}\begin{matrix}{E}_{m + 1} ≡ {f}^{( m + 1 )} - {f}^{( m )} \\ = \frac{1}{\sqrt{n}} {D}_{m}^{- 1 / 2} {A}_{m}^{- 1} {E}_{m} + \frac{1}{\sqrt{n}} {D}_{m}^{- 1 / 2} ( {A}_{m}^{- 1} - {A}_{m - 1}^{- 1} ) {f}^{( m - 1 )} + \\ \frac{1}{\sqrt{n}} ( {D}_{m}^{- 1 / 2} - {D}_{m - 1}^{- 1 / 2} ) {A}_{m - 1}^{- 1} {f}^{( m - 1 )} .\end{matrix} \\ Assume & ( 22 ) \\ \vert 1 - δ t {\underline{λ}}_{m} \vert = {min}_{i} \vert 1 + δ t {λ}_{i}^{( m )} \vert > 1 & ( 23 )\end{matrix}$$

for δt>0, where λₘ>0.
Lemma 1. Let Aₘ, Dₘ and Eₘ be defined in (16), (17) and (22), respectively. Let aₘ and λₘ be defined in (21) and (23), respectively. Assume

$$\sqrt{n} {a}_{m} {\underline{λ}}_{m} - 3 > 0. \\ Then \\ \frac{1}{\sqrt{n}} {‖ {D}_{m}^{- 1 / 2} {A}_{m}^{- 1} {E}_{m} ‖}_{F} < \frac{1}{3} {‖ {E}_{m} ‖}_{F} \qquad ( 24 )$$

for all

$$δ t > {T}_{1} ≡ max \{ \frac{\sqrt{n} {a}_{m}}{\sqrt{n} {a}_{m} {\underline{λ}}_{m} - 3} , {T}_{0} \}$$

where T0 is defined in (20).
Proof. From the assumption in (24), the following is obtained

(\sqrt{n}aₘλₘ−3)δt>\sqrt{n}aₘ, for δt>T₁

which is equivalent to

−3δt>\sqrt{n}aₘ(1−δtλₘ)

and then

3δt<\sqrt{n}aₘ|1−δtλₘ|. (25)

Combing the results in (21) and (25), it holds that

$$\frac{1}{\sqrt{n}} {‖ {D}_{m}^{- 1 / 2} {A}_{m}^{- 1} {E}_{m} ‖}_{F} \leq \frac{1}{\sqrt{n}} \frac{δ t}{{a}_{m} \vert 1 - δ t {\underline{λ}}_{m} \vert} {‖ {E}_{m} ‖}_{F} < \frac{1}{3} {‖ {E}_{m} ‖}_{F} .$$

Lemma 2. Assume that

αₘ≡aₘ\sqrt{n}λₘλₘ₋₁−3b(1+1/\sqrt{n})>0, (26)

where b≡max_{1≦i≦n}∥eᵢ^{T} A∥_{2·}. Then

$$\frac{1}{\sqrt{n}} {‖ {D}_{m}^{- 1 / 2} ( {A}_{m}^{- 1} - {A}_{m - 1}^{- 1} ) {f}^{( m - 1 )} ‖}_{F} < \frac{1}{3} {‖ {E}_{m} ‖}_{F} \qquad ( 27 )$$

for all

$$δ t > {T}_{2} ≡ max \{ {T}_{0} , \frac{- {β}_{m} + \sqrt{{β}_{m}^{2} - 4 {α}_{m} {γ}_{m}}}{2 {α}_{m}} \} ,$$

where T₀ is defined in (20) and

βₘ=−aₘ\sqrt{n}(λₘ+λₘ₋₁), γₘ=αₘ\sqrt{n}.

Proof. By the definition of Aₘ in (16), it holds that

$$\begin{matrix} \begin{matrix}\frac{1}{\sqrt{n}} {D}_{m}^{- 1 / 2} \\ ( {A}_{m}^{- 1} - {A}_{m - 1}^{- 1} ) {f}^{( m - 1 )}\end{matrix} = \frac{1}{\sqrt{n}} {D}_{m}^{- 1 / 2} {A}_{m}^{- 1} ( {A}_{m - 1} - {A}_{m} ) \\ {A}_{m - 1}^{- 1} {f}^{( m - 1 )} \\ = \frac{δ t}{\sqrt{n}} {D}_{m}^{- 1 / 2} {A}_{m}^{- 1} ( ≺ A {f}^{( m )} , \\ {f}^{( m )} ≻ - ≺ A {f}^{( m - 1 )} , {f}^{( m - 1 )} ≻ ) \\ {A}_{m - 1}^{- 1} {f}^{( m - 1 )} \\ = \frac{δ t}{\sqrt{n}} {D}_{m}^{- 1 / 2} {A}_{m}^{- 1} ( ≺ A {f}^{( m )} , \\ {E}_{m} ≻ + ≺ {AE}_{m} , {f}^{( m - 1 )} ≻ ) \\ {A}_{m - 1}^{- 1} {f}^{( m - 1 )} .\end{matrix} \\ Since \\ \begin{matrix} \begin{matrix}{‖ ≺ A {f}^{( m )} , {E}_{m} ≻ ‖}_{2} \leq \\ {max}_{i} {‖ {e}_{i}^{T} A ‖}_{2} {‖ {f}^{( m )} ‖}_{F} {‖ {E}_{m} ‖}_{F}\end{matrix} = {max}_{i} {‖ {e}_{i}^{T} A ‖}_{2} \\ {‖ {E}_{m} ‖}_{F} \\ ≡ b {‖ {E}_{m} ‖}_{F}\end{matrix} \\ and \\ \begin{matrix} {‖ ≺ {AE}_{m} , {f}^{( m - 1 )} ≻ ‖}_{2} = {max}_{i} \vert ( {e}_{i}^{T} {AE}_{m} ) {( {e}_{i}^{T} {f}^{( m - 1 )} )}^{′} \vert \leq \\ {max}_{i} {‖ {e}_{i}^{T} {AE}_{m} ‖}_{2} {max}_{i} {‖ {e}_{i}^{T} {f}^{( m - 1 )} ‖}_{2} \leq \\ {max}_{i} {‖ {e}_{i}^{T} A ‖}_{2} \frac{1}{\sqrt{n}} {‖ {E}_{m} ‖}_{F} \\ ≡ \frac{b}{\sqrt{n}} {‖ {E}_{m} ‖}_{F} ,\end{matrix} \\ thus \\ \frac{1}{\sqrt{n}} {‖ {D}_{m}^{- 1 / 2} ( {A}_{m}^{- 1} - {A}_{m - 1}^{- 1} ) {f}^{( m - 1 )} ‖}_{F} \leq \frac{{( δ t )}^{2}}{\sqrt{n}} \frac{b + b / \sqrt{n}}{\vert 1 - δ t {\underline{λ}}_{m} \vert \cdot \vert 1 - δ t {\underline{λ}}_{m - 1} \vert {a}_{m}} {‖ {E}_{m} ‖}_{F} {‖ {f}^{( m - 1 )} ‖}_{F} = \frac{{( δ t )}^{2}}{\sqrt{n}} \frac{b + b / \sqrt{n}}{\vert 1 - δ t {\underline{λ}}_{m} \vert \cdot \vert 1 - δ t {\underline{λ}}_{m - 1} \vert {a}_{m}} {‖ {E}_{m} ‖}_{F} . \qquad ( 28 )$$

By the definitions of αₘ, βₘ and γₘ, it follows that

βₘ²4αₘγₘ=naₘ²(λₘ−λₘ₋₁)²+12\sqrt{n}aₘb(1+1/\sqrt{n})>0.
Using the assumption αm>0, for all δt>T2, the following is obtained

$$( δ t - \frac{- {β}_{m} + \sqrt{{β}_{m}^{2} - 4 {α}_{m} {γ}_{m}}}{2 {α}_{m}} ) ( δ t - \frac{- {β}_{m} - \sqrt{{β}_{m}^{2} - 4 {α}_{m} {γ}_{m}}}{2 {α}_{m}} ) > 0$$

which implies that

\sqrt{n}aₘ [1−(λₘ+λₘ₋₁)δt+λₘλₘ₋₁(δt)²]>3b(1+1/\sqrt{n})(δt)².
Consequently,

$$\frac{{( δ t )}^{2}}{\sqrt{n}} \frac{b + b / \sqrt{n}}{\vert 1 - δ t {\underline{λ}}_{m} \vert \cdot \vert 1 - δ t {\underline{λ}}_{m - 1} \vert {a}_{m}} < \frac{1}{3} . \qquad ( 29 )$$

Substituting (29) into (28), the result in (27) is obtained.
Lemma 3. Assume that

$${min}_{1 \leq i \leq n} {‖ {q}_{i , m}^{T} {A}_{m}^{- 1} {Q}_{m}^{T} {f}^{( m )} ‖}_{2} > {η}_{m} , \qquad ( 30 )$$

3(|λₘ|+|λₘ₋₁|)(b+b/√n)+6|λₘλₘ₋₁|<\sqrt{n}aₘaₘ₋₁cₘλₘ²λₘ₋₁²|λₘ|, (31)

where ηₘ is defined in (20) and

$${c}_{m} = {min}_{i} ( {‖ {q}_{i , m}^{T} {A}_{m}^{- 1} {Q}_{m}^{T} {f}^{( m )} ‖}_{2} + {‖ {q}_{i , m - 1}^{T} {A}_{m - 1}^{- 1} {Q}_{m - 1}^{T} {f}^{( m - 1 )} ‖}_{2} - {η}_{m} - {η}_{m - 1} ) .$$

Then there exists T₃>0 such that

$$\frac{1}{\sqrt{η}} {‖ ( {D}_{m}^{- 1 / 2} - {D}_{m - 1}^{- 1 / 2} ) {A}_{m - 1}^{- 1} {f}^{( m - 1 )} ‖}_{F} < \frac{1}{3} {‖ {E}_{m} ‖}_{F}$$

for δt≧T₃.
Proof. The third term on the right hand side of (22) is rewritten as

$$\frac{1}{\sqrt{η}} ( {D}_{m}^{- 1 / 2} - {D}_{m - 1}^{- 1 / 2} ) {A}_{m - 1}^{- 1} {f}^{( m - 1 )} = \frac{1}{\sqrt{η}} ( {D}_{m} - {D}_{m - 1} ) \{ {D}_{m}^{- 1 / 2} {{D}_{m - 1}^{- 1 / 2} ( {D}_{m}^{1 / 2} + {D}_{m - 1}^{1 / 2} )}^{- 1} \} {A}_{m - 1}^{- 1} {f}^{( m - 1 )} . \qquad ( 32 )$$

From (19) and (20), the following is obtained

$$\begin{matrix}{w}_{i} ≡ {e}_{i}^{T} ( {D}_{m}^{1 / 2} + {D}_{m - 1}^{1 / 2} ) {e}_{i} \\ = \frac{1}{δ t} \{ {‖ {q}_{i , m}^{T} {Λ}_{m}^{- 1} {Q}_{m}^{T} {f}^{( m )} + {m}_{} ( \frac{1}{δ t} ) ‖}_{2} + \\ {‖ {q}_{i , m - 1}^{T} {Λ}_{m - 1}^{- 1} {Q}_{m - 1}^{T} {f}^{( m - 1 )} + {m - 1}_{} ( \frac{1}{δ t} ) ‖}_{2} \} \geq \\ \frac{1}{δ t} \{ {‖ {q}_{i , m}^{T} {Λ}_{m}^{- 1} {Q}_{m}^{T} {f}^{( m )} ‖}_{2} + {‖ {q}_{i , m - 1}^{T} {Λ}_{m - 1}^{- 1} {Q}_{m - 1}^{T} {f}^{( m - 1 )} ‖}_{2} - \\ {η}_{m} - {η}_{m - 1} \}\end{matrix}$$

for δt≧T₀, which implies that

$$\begin{matrix}{‖ {( {D}_{m}^{1 / 2} + {D}_{m - 1}^{1 / 2} )}^{- 1} ‖}_{2} = {max}_{1 \leq i \leq n} {w}_{i}^{- 1} \\ = {\{ {max}_{1 \leq i \leq n} {w}_{i} \}}^{- 1} \leq δ t \{ {min}_{i} \\ ( {‖ {q}_{i , m}^{T} {Λ}_{m}^{- 1} {Q}_{m}^{T} {f}^{( m )} ‖}_{2} + \\ {‖ {q}_{i , m - 1}^{T} {Λ}_{m - 1}^{- 1} {Q}_{m - 1}^{T} {f}^{( m - 1 )} ‖}_{2} - {η}_{m} - \\ { {η}_{m - 1} ) \}}^{- 1} \\ ≡ \frac{δ t}{{c}_{m}} .\end{matrix} \qquad ( 33 )$$

On the other hand,

$$\begin{matrix}{D}_{m} - {D}_{m - 1} = ≺ {A}_{m}^{- 1} {f}^{( m )} , {A}_{m}^{- 1} {f}^{( m )} ≻ - ≺ {A}_{m}^{- 1} {f}^{( m )} , {A}_{m}^{- 1} {f}^{( m )} ≻ \\ = ≺ {A}_{m}^{- 1} {f}^{( m )} , ( {A}_{m}^{- 1} - {A}_{m - 1}^{- 1} ) {f}^{( m )} ≻ + \\ ≺ {A}_{m}^{- 1} {f}^{( m )} , {A}_{m - 1}^{- 1} {E}_{m} ≻ + \\ ≺ {A}_{m}^{- 1} {E}_{m} , {A}_{m - 1}^{- 1} {f}^{( m - 1 )} ≻ + \\ ≺ ( {A}_{m}^{- 1} - {A}_{m - 1}^{- 1} ) {f}^{( m - 1 )} , {A}_{m - 1}^{- 1} {f}^{( m - 1 )} ≻ .\end{matrix} \qquad ( 34 )$$

From (28), it follows that

$${‖ {A}_{m}^{- 1} - {A}_{m - 1}^{- 1} ‖}_{2} \leq \frac{( b + b / \sqrt{n} ) δ t}{\vert 1 - δ t {\underline{λ}}_{m} \vert \cdot \vert 1 - δ t {\underline{λ}}_{m - 1} \vert} {‖ {E}_{m} ‖}_{F} . \qquad ( 35 )$$

From (23), (34) and (35) with the results, the following is obtained

$${‖ {D}_{m} - {D}_{m - 1} ‖}_{2} \leq {‖ ≺ {A}_{m}^{- 1} {f}^{( m )} , ( {A}_{m}^{- 1} - {A}_{m - 1}^{- 1} ) {f}^{( m )} ≻ ‖}_{2} + {‖ ≺ {A}_{m}^{- 1} {f}^{( m )} , {A}_{m - 1}^{- 1} {E}_{m} ≻ ‖}_{2} + {‖ ≺ {A}_{m}^{- 1} {E}_{m} , {A}_{m - 1}^{- 1} {f}^{( m - 1 )} ≻ ‖}_{2} + {‖ ≺ ( {A}_{m}^{- 1} - {A}_{m - 1}^{- 1} ) {f}^{( m - 1 )} , {A}_{m - 1}^{- 1} {f}^{( m - 1 )} ≻ ‖}_{2} \leq ( {‖ {A}_{m}^{- 1} ‖}_{2} + {‖ {A}_{m - 1}^{- 1} ‖}_{2} ) {‖ {A}_{m}^{- 1} - {A}_{m - 1}^{- 1} ‖}_{2} + 2 {‖ {A}_{m}^{- 1} ‖}_{2} {‖ {A}_{m - 1}^{- 1} ‖}_{2} {‖ {E}_{m} ‖}_{2} \leq ( \frac{1}{\vert 1 - δ t {\underline{λ}}_{m} \vert} + \frac{1}{\vert 1 - δ t {\underline{λ}}_{m - 1} \vert} ) \frac{( b + b / \sqrt{n} ) δ t}{\vert 1 - δ t {\underline{λ}}_{m} \vert \cdot \vert 1 - δ t {\underline{λ}}_{m - 1} \vert} {‖ {E}_{m} ‖}_{F} + \frac{2}{\vert 1 - δ t {\underline{λ}}_{m} \vert \cdot \vert 1 - δ t {\underline{λ}}_{m - 1} \vert} {‖ {E}_{m} ‖}_{F} . \qquad ( 36 )$$

Using (23), (34) and (35) and the assumption (31), (32) implies that

$$\frac{1}{\sqrt{n}} {‖ ( {D}_{m}^{- 1 / 2} - {D}_{m - 1}^{- 1 / 2} ) {A}_{m - 1}^{- 1} {f}^{( m - 1 )} ‖}_{F} \leq {‖ {D}_{m} - {D}_{m - 1} ‖}_{2} {‖ {D}_{m}^{- 1 / 2} ‖}_{2} {‖ {D}_{m - 1}^{- 1 / 2} ‖}_{2} {‖ {( {D}_{m}^{1 / 2} + {D}_{m - 1}^{1 / 2} )}^{- 1} ‖}_{2} {‖ {A}_{m - 1}^{- 1} ‖}_{2} \leq \frac{1}{\sqrt{n}} \frac{δ t}{{a}_{m}} \frac{δ t}{{a}_{m - 1}} \frac{1}{\vert 1 - δ t {\underline{λ}}_{m} \vert} \frac{δ t}{{c}_{m}} \{ \frac{2}{\vert 1 - δ t {\underline{λ}}_{m} \vert \cdot \vert 1 - δ t {\underline{λ}}_{m - 1} \vert} + ( \frac{1}{\vert 1 - δ t {\underline{λ}}_{m} \vert} + \frac{1}{\vert 1 - δ t {\underline{λ}}_{m - 1} \vert} ) \frac{( b + b / \sqrt{n} ) δ t}{\vert 1 - δ t {\underline{λ}}_{m} \vert \cdot \vert 1 - δ t {\underline{λ}}_{m - 1} \vert} \} {‖ {E}_{m} ‖}_{F} = \frac{{( δ t )}^{2}}{\sqrt{n} {a}_{m} {a}_{m - 1} {{c}_{m} ( 1 - δ t {\underline{λ}}_{m} )}^{2} \vert 1 - δ t {\underline{λ}}_{m - 1} \vert} \times \{ 2 + ( \frac{1}{\vert 1 - δ t {\underline{λ}}_{m} \vert} + \frac{1}{\vert 1 - δ t {\underline{λ}}_{m - 1} \vert} ) ( b + b / \sqrt{n} ) δ t \} < \frac{1}{3} {‖ {E}_{m} ‖}_{F} , \\ ( by the assumption ( 31 ) )$$

for δt≧T₃ with large enough T₃.
Using the results in Lemmas 1, 2 and 3 into (22), the decrease of the error ∥Eₘ∥_{F} is easily shown.
Theorem 1. Assume that inequalities of (24), (26), (30) and (31) hold.
Then there exists T>0 such that

∥Eₘ∥_{F}≡∥f^{(m+1)}−f^{(m)}∥_{F}<∥f^{(m)}−f^{(m-1)}∥_{F}≡∥Eₘ₋₁∥_{F}

for all δt>T.
Now, a more simplified case for f^{(m)} and f^{(m+1)} without normalization is considered. Assume

∥eᵢ^{T}f^{(m-1)}∥₂=1, for i=1, . . . , n. (37)

Let

f^{(m)}=Aₘ₋₁⁻¹f^{(m-1)}, f^{(m+1)}=Aₘ⁻¹f^{(m)},

where Aₘ is defined in (16) and

αₘ=λₘ₋₁λₘ, (38)

βₘ=λₘ+λₘ₋₁+4b\sqrt{n}. (39)

where λₘ is defined in (23). Then f^{(m-1)}, f^{(m)} and f^{(m+1)} satisfy the following result.
Theorem 2. Assume αₘ, βₘ²−4αₘ>0. If δt satisfies that

$$\begin{matrix}δ t > \{ \begin{matrix}( \sqrt{n} + 1 ) / {\underline{λ}}_{m} , & if {\underline{λ}}_{m} > 0 ; \\ ( \sqrt{n} - 1 ) / ( - {\underline{λ}}_{m} ) , & if {\underline{λ}}_{m} < 0 ,\end{matrix} \\ and & ( 40 ) \\ δ t > \frac{{β}_{m} + \sqrt{{β}_{m}^{2} - 4 {α}_{m}}}{4 {α}_{m}} , \\ then \\ {‖ {f}^{( m + 1 )} - {f}^{( m )} ‖}_{F} < {‖ {f}^{( m )} - {f}^{( m - 1 )} ‖}_{F} . & ( 41 )\end{matrix}$$

Proof. From (16), the following is obtained

$$\begin{matrix}{E}_{m + 1} ≡ {f}^{( m + 1 )} - {f}^{( m )} \\ = {A}_{m}^{- 1} {f}^{( m )} - {A}_{m - 1}^{- 1} {f}^{( m - 1 )} \\ = {A}_{m}^{- 1} {f}^{( m )} - {A}_{m}^{- 1} {f}^{( m - 1 )} + {A}_{m}^{- 1} {f}^{( m - 1 )} - {A}_{m - 1}^{- 1} {f}^{( m - 1 )} \\ = {A}_{m}^{- 1} {E}_{m} + {A}_{m}^{- 1} ( {A}_{m - 1} - {A}_{m} ) {A}_{m - 1}^{- 1} {f}^{( m - 1 )} \\ = {A}_{m}^{- 1} {E}_{m} + ( δ t ) {A}_{m}^{- 1} ( ≺ A {f}^{( m )} , {f}^{( m )} ≻ - ≺ A {f}^{( m - 1 )} , \\ {f}^{( m - 1 )} ≻ ) {A}_{m - 1}^{- 1} {f}^{( m - 1 )} \\ = {A}_{m}^{- 1} {E}_{m} + ( δ t ) {A}_{m}^{- 1} ( ≺ A {f}^{( m )} , {f}^{( m )} ≻ - ≺ A {f}^{( m )} , \\ {f}^{( m - 1 )} ≻ + ≺ A {f}^{( m )} , {f}^{( m - 1 )} ≻ - ≺ A {f}^{( m - 1 )} , \\ {f}^{( m - 1 )} ≻ ) {A}_{m - 1}^{- 1} {f}^{( m - 1 )} .\end{matrix} \qquad ( 42 )$$

By QIEM definition 1, it holds that

$$\begin{matrix}{‖ ≺ A {f}^{( m )} , {f}^{( m - 1 )} ≻ - ≺ A {f}^{( m - 1 )} , {f}^{( m - 1 )} ≻ ‖}_{2} = {‖ ≺ {AE}_{m} , {f}^{( m - 1 )} ≻ ‖}_{2} \\ = {max}_{1 \leq i \leq n} \vert {e}_{i}^{T} {AE}_{m} \\ {( {f}^{( m - 1 )} )}^{T} {e}_{i} \vert .\end{matrix}$$

By the assumption in (37), the following is obtained

$${‖ ≺ A {f}^{( m )} , {f}^{( m - 1 )} ≻ - ≺ A {f}^{( m - 1 )} , {f}^{( m - 1 )} ≻ ‖}_{2} \leq {max}_{1 \leq i \leq n} {‖ {e}_{i}^{T} {AE}_{m} ‖}_{2} \leq {max}_{1 \leq i \leq n} {‖ {e}_{i}^{T} A ‖}_{2} {‖ {E}_{m} ‖}_{F} ≡ b {‖ {E}_{m} ‖}_{F} . \qquad ( 43 )$$

On the other hand, using f(m) and (16), (23) and (37), it holds that

$${‖ ≺ A {f}^{( m )} , {f}^{( m )} ≻ - ≺ A {f}^{( m )} , {f}^{( m - 1 )} ≻ ‖}_{2} = {max}_{1 \leq i \leq n} \vert {e}_{i}^{T} {AA}_{m}^{- 1} {f}^{( m - 1 )} {E}_{m}^{T} {e}_{i} \vert \leq {max}_{1 \leq i \leq n} {‖ {e}_{i}^{T} A ‖}_{2} {‖ {A}_{m}^{- 1} ‖}_{2} {‖ {f}^{( m - 1 )} ‖}_{2} {‖ {E}_{m} ‖}_{F} \leq \frac{b \sqrt{n}}{\vert 1 - {\underline{λ}}_{m} δ t \vert} {‖ {E}_{m} ‖}_{F} . \qquad ( 44 )$$

The assumption in (40) implies that

$$\frac{\sqrt{n}}{\vert 1 - {\underline{λ}}_{m} δ t \vert} < 1 and \frac{1}{\vert 1 - {\underline{λ}}_{m} δ t \vert} < \frac{1}{\sqrt{n}} < \frac{1}{2} , if n > 4. \qquad ( 45 )$$

Consequently, from (44),

∥ [symbol] Af^{(m)}, f^{(m)} [symbol] − [symbol] Af^{(m)}, f^{(m-1)} [symbol] ∥₂<b∥Eₘ∥_{F}. (46)
From (42), (43) and (46), the following is obtained

$${‖ {E}_{m + 1} ‖}_{F} < {‖ {A}_{m}^{- 1} ‖}_{2} {‖ {E}_{m} ‖}_{F} + 2 b ( δ t ) {‖ {A}_{m}^{- 1} ‖}_{2} {‖ {A}_{m - 1}^{- 1} ‖}_{2} {‖ {f}^{( m - 1 )} ‖}_{2} {‖ {E}_{m} ‖}_{F} < \{ \frac{1}{\vert 1 - {\underline{λ}}_{m} δ t \vert} + \frac{2 b ( δ t ) \sqrt{n}}{\vert 1 - {\underline{λ}}_{m - 1} δ t \vert \vert 1 - {\underline{λ}}_{m} δ t \vert} \} {‖ {E}_{m} ‖}_{F} . \qquad ( 47 )$$

By the assumption that αₘ, βₘ²−4αₘ>0, for all

$$δ t > \frac{{β}_{m} + \sqrt{{β}_{m}^{2} - 4 {α}_{m}}}{2 {α}_{m}} , \\ ( δ t - \frac{{β}_{m} + \sqrt{{β}_{m}^{2} - 4 {α}_{m}}}{2 {α}_{m}} ) ( δ t - \frac{{β}_{m} - \sqrt{{β}_{m}^{2} - 4 {α}_{m}}}{2 {α}_{m}} ) > 0$$

which implies that

$$[ 1 - ( {\underline{λ}}_{m} + {\underline{λ}}_{m - 1} ) δ t + {\underline{λ}}_{m} {\underline{λ}}_{m - 1} {( δ t )}^{2} ] > 4 b \sqrt{n} δ t \\ And \\ \frac{2 b ( δt ) \sqrt{n}}{\vert 1 - {\underline{λ}}_{m - 1} δ t \vert \vert 1 - {\underline{λ}}_{m} δ t \vert} < \frac{1}{2} . \qquad ( 48 )$$

Substituting (45) and (48) into (47), it holds that ∥Eₘ₊₁∥_{F}<∥Eₘ∥_{F}.

### Practical Implementation

How to efficiently compute the steady state solution of (10) with zero mass-center normalization by QIEM will be discussed.

1. The Initial Mapping f⁽⁰⁾

For the spherical conformal mapping on genus-zero closed surfaces, the initial map f⁽⁰⁾ in (14) is to construct an one-to-one and onto smooth map from a given genus-zero closed surface to the unit sphere. In practice, the Gauss map is used as the initial map f⁽⁰⁾, which is defined as follows:
Definition of Gauss map. [symbol] : M→ [symbol] ², G(v)=n(v), where n(v) is the unit normal vector at v ∈ M.
   The corresponding Gauss map can be computed, for instance, as the weighted sum of normals on the adjacent faces weighed by their areas.

For the case of simply connected surfaces with a single boundary, i.e., computing the Riemann mapping, the idea described in Connectivity shapes in proceedings of IEEE Visualization 2001, pp. 135-142, IEEE Computer Society, 2001 to construct a harmonic-type initial map. Specifically, first the open surface is parametrized onto a unit disk by the harmonic map. Using the stereographic projection, the resulting mesh is mapped to a lower hemisphere. Then the harmonic-type initial map is obtained by reflecting the hemisphere's image along the equatorial plane to built a full unit sphere.

### 2. Adaptive Time Step Control

The convergence of solving the steady state solution of the time-dependent differential equations with fixed time step δt may be very slow. In order to accelerate the convergence, a time step controlling scheme is proposed to control δt in (14) for each iteration m. As a consequence, the sequence {f^{(m)}} can be convergent as soon as possible.

Let δt₀ be an initial time step and δtₘₐₓ denote the maximal time step so that δt is set to be δtₘₐₓ if δt>δₘₐₓ. The strategy of choosing δt in each iteration is based on the decrement of the harmonic energy εₕ(f), i.e., the time steps are chosen such that the harmonic energy is always decreasing in each iteration. This objective can be achieved by the descending and accelerating strategies of time step controls. The descending strategy is used to determine δt so that εₕ(f^{(m+1)}) is always decreasing, i.e., εₕ(f^{(m+1)})−εₕ(f^{(m)})<ε, in each m=0, 1, . . . , k for some k and tolerance ε. Given ε, δt₀ and an increment α, the strategy is described as follows.
(S₂.a) If εₕ(f^{(m+1)})−εₕ(f^{(m)})≧ε, then introduce δt to be δt:=1/2δt and recompute f^{(m+1)} from (14). This step prevents the sequence {f^{(m)}} converges to a map whose harmonic energy is a local extreme.
(S₂.b) If the new εₕ(f^{(m+1)}) is still larger than εₕ(f^{(m)}) when δt has been repeatedly reduced three times, then the initial δt₀ is introduced to be δt₀:=δt₀/α and the algorithm is restarted with m=0.

The iteration in (14) with the descending strategy is repeated till εₕ(f^{(m+1)}) is closed enough to εₕ(f^{(m)}). After the descending strategy, the following accelerating strategy is used to increase δt and to speed up the convergence further.
(S₂.c) If Εh(f(m+1)) satisfies that |εₕ(f^{(m+1)})−εₕ(f^{(m)})|<10×|εₕ(f^{(m)})−εₕ(f^{(m-1)})|, then δt is increased by δt:=min(δtₘₐₓ, δt×α); otherwise, δt is too large, will be reduced by δt:=δt/α and f^{(m+1)} is recomputed from (14).

### 3. Two-Phase Quasi-Implicit Euler Method

To determine the initial map f⁽⁰⁾ in (14) is a crucial cornerstone to implement the QIEM for the evolution of conformal mappings on the unit sphere or on the unit disk. If f⁽⁰⁾ is not close to the steady state solution, then it is difficult to find a large stable convergence region of the time steps for solving (10) by QIEM with time step controlling strategies (S₂.a), (S₂.b) and (S₂.c). To remedy this drawback, a two-phase QIEM is proposed. If f⁽⁰⁾ is not close to the steady state solution, the heuristic phase-I QIEM

$$\frac{\vert {f}^{( m + 1 )} - {f}^{( m )}}{δ t} = - {Δ}_{d} {f}^{( m + 1 )} = - {Af}^{ ( m + 1 )} , \\ i . e . , \\ ( I + ( δ t ) A ) {f}^{( m + 1 )} = {f}^{( m )}$$

is used to compute f^{(m+1)}. When f^{(m)} is close to the steady state solution, switch to (14) with strategies (S₂.a), (S₂.b) and (S₂.c) for computing f^{(m+1)}. This is called the phase-II QIEM.

To set up a robust phase-I QIEM, an adaptive method is also proposed, just as the phase-II QIEM, to control δt in each iteration. The strategy described as follows is repeated until the difference |εₕ(f^{(m+1)})−εₕ(f^{(m)})| of the energy is less than a given tolerance ε₃.
(S₁.a) By the definition of A in (7), the row sums of A are equal to zero which implies that there is a trivial solution f such that (A− [symbol] Af, f [symbol] )f=0 and εₕ(f)=0. To avoid f^{(m)} convergent to this trivial solution, reset δt₀ to be the current δt and restart the algorithm with the original f⁽⁰⁾ and new δt₀ when εₕ(f^{(m)}) is less than a given small tolerance ε₂.
(S₁.b) If εₕ(f^{(m+1)}) does not decrease, then δt is reduced to be δt:=max(1, 1/2δt) and recompute f^{(m+1)} from (14).
(S₁.c) If the difference of the energy is still larger than or equal to ε₃ when m has been larger than a given maximal iteration number mₘₐₓ, reset δt₀ to be the current δt and restart the algorithm with original initial closed surface f⁽⁰⁾ and new δt₀.

It is important to determine δt₀ for solving the steady state problem. In general, the explicit Euler method has extremely narrow stability region of time steps which leads to the extremely slow convergence. The implicit Euler method has considerably wider stability region. However, it involves nonlinear systems that have to be solved by iterative solvers. If the time step is larger, then the initial guess of the iterative solver must be unrealistically close to the solution of the nonlinear systems. For two phases of QIEM, a heuristic method is proposed in Algorithm 1 to determine an initial time step. Comparing the initial time step in Algorithm 1 with those for the explicit and implicit Euler methods, the proposed time step is large.
The algorithm of “Two-phase quasi-implicit Euler method” is stated as the following Algorithm 1.
Input: A genus zero triangular mesh M, an initial map f⁽⁰⁾ with the harmonic energy εₕ(f⁽⁰⁾) and a threshold δΕ for the energy difference.
Output: Convergent steady state solution f^{(m)} with zero mass center.
   1: Compute the areas [symbol] ᵢ, i=1, . . . , n, of all faces in M;
   2: Resort [symbol] ᵢ for i=1, . . . , n;
   3: Compute the average [symbol] of the areas [symbol] ᵢ for i=0.45 n, . . . , 0.55 n;
   4: Find the minimal positive integer k such that [symbol] ^{k/3-7}·≦3500.
   5: Compute δt₀= [symbol] ^{k/2-7}·.
   6: if f⁽⁰⁾ is not close to the steady state solution then
   7: repeat
   8: Solve the linear system

(I+(δt)A)f^{(m+1)}=f^{(m)}.
9: Compute the mass sphere center c:

$$c = {( {\sum }_{i = 1}^{n} ( {v}_{i} ) )}^{- 1} [ ( {v}_{i} ) … ( {v}_{n} ) ] {f}^{( m + 1 )} , \qquad ( 49 )$$

where [symbol] (υᵢ) is the sum of areas for the faces which have the common vertex vᵢ, i=1, . . . , n;
10: Normalize f^{(m+1)} by (f^{(m+1)}−c)/∥f^{(m+1)}−c∥ such that the mass center of the resulting f^{(m+1)} is at the unit sphere center;
11: Compute δt according to strategies (S₁.a), (S₁.b) and (S₁.c) with mₘₐₓ=10, ε₂=0.5 and ε₃=0.1;
12: until |εₕ(f^{(m+1)})−εₕ(f^{(m)})|<0.1
13: Set f⁽⁰⁾=f^{(m+1)} and m=0;
14: end if
15: repeat
16: Solve the linear system

{I+δt(A− [symbol] Af^{(m)}, f^{(m)} [symbol] )}f^{(m+1)}=f^{(m)}.
17: Compute the mass sphere center c in (49);
18: Normalize f^{(m+1)} by (f^{(m+1)}−c)/f^{(m+1)}−c∥ such that the mass center of the resulting f^{(m+1)} is at the unit sphere center;
19: Compute δt according to strategies (S₂.a), (S₂.b) and (S₂.c) with α=1.05 and ε=0.05;
20: until |εₕ(f^{(m+1)})−εₕ(f^{(m)})|<δΕ

### Numerical Results

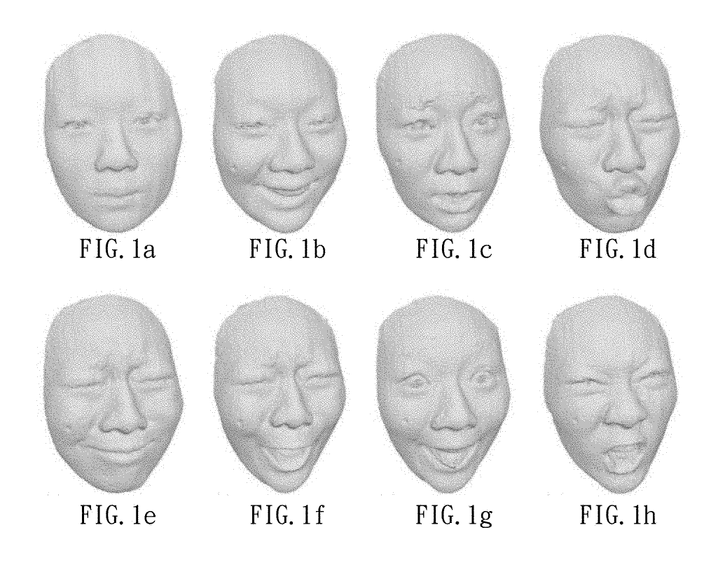

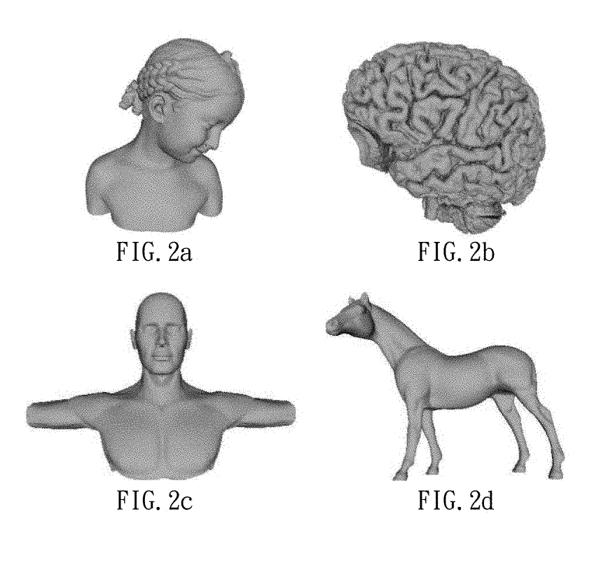

The performances of the computation of Riemann and sphere conformal mappings are evaluated by numerical experiments. The benchmark problems come from the eight different facial expressions for a person in FIG. 1 and four different genus zero closed surfaces in FIG. 2, respectively. The corresponding mesh data are listed in Table 1.

All computations are carried out in MATLAB 2011b on a HP workstation with two Intel Quad-Core Xeon X5687 3.6 GHz CPUs, 48 GB main memory and RedHat Linux operation system, using IEEE double-precision floating-point arithmetic.

### 1. Efficiency of Computing Riemann Mapping by Algorithm 1

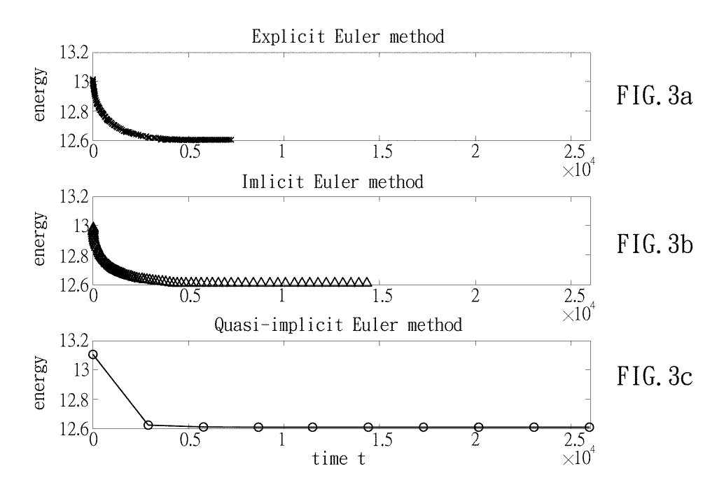

The efficiency of Algorithm 1 in solving the nonlinear heat diffusion equation (10) with zero mass center by (i) comparing the efficiency of the explicit, implicit and quasi-implicit Euler methods, (ii) robustness in choosing initial time step and (iii) high performance computing for the benchmark human faces in FIG. 1, is demonstrated. In (i) and (ii), the human face in FIG. 1(a) is used as the benchmark problem. The stopping tolerance δΕ is taken as 10⁻⁹. The initial map f⁽⁰⁾ are all constructed by the harmonic-type initial map (see Section 5.1). Such f⁽⁰⁾ is close to the steady state solution so that the phase-I QIEM, i.e., lines 7-13, is skipped in Algorithm 1 Only phase-II QIEM, i.e., lines 15-20, is used to compute the steady state solution.
Comparison for the explicit, implicit and quasi-implicit Euler methods:
The time steps δt for the explicit, implicit and quasi-implicit Euler methods are set to 0.003, 5 and 2881.05, respectively. The energy εₕ(f^{(m)} produced by Algorithm 1 is strictly monotonically decreasing so that δt is fixed at each iteration. In order to accelerate the convergence of the implicit Euler method, an adaptive method is applied to control time step. For explicit Euler method, δt is fixed in each iteration. The numerical results of the explicit, implicit and quasi-implicit Euler methods are shown in Table 2. The notation #it in Table 2 denotes the total iteration number used to compute the solution. The convergence behaviors for these three methods are shown in FIG. 3. From these numerical results, it is learned that the QIEM outperforms the explicit and implicit Euler methods greatly.

TABLE 1
#V and #F denote the numbers of vertices and faces of M,
respectively, dim is the dimension of the matrix A.

| FIG. | #F | #V | dim |
|---|---|---|---|
| 1(a) | 102256 | 51596 | 102258 |
| 1(b) | 135766 | 68430 | 135768 |
| 1(c) | 136513 | 68802 | 136515 |
| 1(d) | 127265 | 64156 | 127267 |
| 1(e) | 127132 | 64095 | 127134 |
| 1(f) | 130560 | 65802 | 130562 |
| 1(g) | 140352 | 70720 | 140354 |
| 1(h) | 139198 | 70180 | 139200 |
| 2(a) | 1005146 | 502575 | 502575 |
| 2(b) | 858180 | 429092 | 429092 |
| 2(c) | 284692 | 142348 | 142348 |
| 2(d) | 39698 | 19851 | 19851 |

TABLE 2
Efficiency comparison

| | Explicit Euler | Implicit Euler | QIEM |
|---|---|---|---|
| δt | 0.003 | 5 | 2,881.05 |
| #it | 2,412,000 | 108 | 10 |
| CPU time (sec.) | 113,911.89 | 5,554.88 | 4.23 |

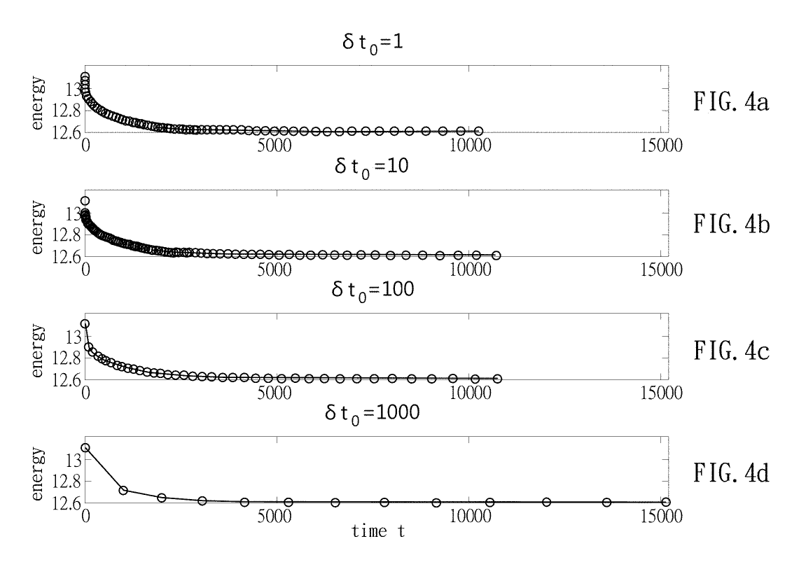

Robustness of choosing initial time step in Algorithm 1: The numerical results have validated that the QIEM with the time step δt=2881.05, which is estimated by Algorithm 1, outperforms the other two methods by big margins. Now, the robustness of Algorithml with the harmonic-type initial map f (0) for solving (10) with human face in FIG. 1(a) is demonstrated. Four different initial time steps δt₀, namely (1, 10, 100, 1000), are applied to solve the steady state problem and the maximum δtₘₐₓ of time steps is equal to 2881.05. The associated numerical results are shown in Table 3 and the convergence behaviors of the harmonic energy are shown in FIG. 4. The notation δt_{end} in Table 3 denotes the time step at the final iteration. The results in Table 3 and FIG. 4 show that no matter which initial time step is used, the adaptive controlling processes in Algorithm 1 performs well. The time step in each iteration is effectively increasing and the convergence of the solution is accelerated. Furthermore, these results also show that the QIEM with a harmonic-type initial f⁽⁰⁾ has a wide stability region and the process of estimating time step in Algorithm 1 provides a near optimal initial time step.

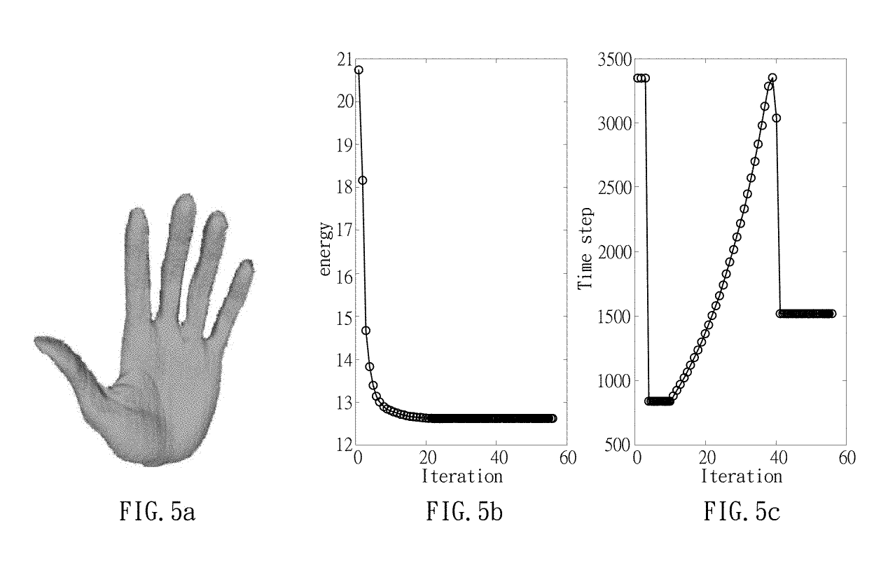

The adaptive controlling time step is not only robust for the human face problems but also for other benchmark problems. FIG. 5(b) presents the numerical results for applying Algorithm 1 to compute the Riemann mapping of the human hand in FIG. 5(a). As shown in FIG. 5(b), the time step is reduced from 3348.76 to 837.19 at the fourth iteration and then gradually increased to 3348.7. At the 41th iteration, it is again reduced to 1518.71 so that the harmonic energies are always decreasing.
In each iteration, the time step is kept greater than or equal to 837.19 such that it only requires 56 iterations and 103.3 seconds to compute the Riemann mapping.

TABLE 3
Numerical results for Algorithm 1 with
different initial time step δt₀.

| δt₀ | 1 | 10 | 100 | 1000 |
|---|---|---|---|---|
| δt _{end} | 467.5 | 495.6 | 579.2 | 1551 |
| #it | 129 | 83 | 39 | 13 |
| CPU time | 52.4 | 33.9 | 16.1 | 5.63 |
| (sec.) | | | | |

High performance computing for Algorithm 1: the high performance computing for Algorithm 1 with harmonic-type initial map f⁽⁰⁾ in solving the benchmark problems in FIG. 1 is demonstrated. The numerical results are shown in Table 4. The notation t_{c} in the table denotes the total CPU time for computing the conformal map by Algorithm 1 From Table 4, Algorithm 1 provides a large initial time step δt₀. Using such δt₀, it only needs 7˜15 iterations in Algorithm 1 to compute the steady state solution of (10). The associated CPU times are less than 17 seconds for FIG. 1, which illustrates the high performance of Algorithm 1.

TABLE 4
Numerical results for the benchmark problems produced by
Algorithm 1 with harmonic-type initial map f (0).

| FIG. | δt₀ | #it | t_{c} (sec.) |
|---|---|---|---|
| 1(a) | 2881.1 | 10 | 4.23 |
| 1(b) | 3377.7 | 8 | 4.80 |
| 1(c) | 3375.1 | 7 | 4.34 |
| 1(d) | 2890.6 | 11 | 6.02 |
| 1(e) | 2155.6 | 10 | 5.46 |
| 1(f) | 3307.4 | 15 | 8.11 |
| 1(g) | 2102.3 | 13 | 8.08 |
| 1(h) | 3474.0 | 11 | 16.9 |

### 2. Efficiency of Algorithm 1 for Computing Spherical Conformal Mapping

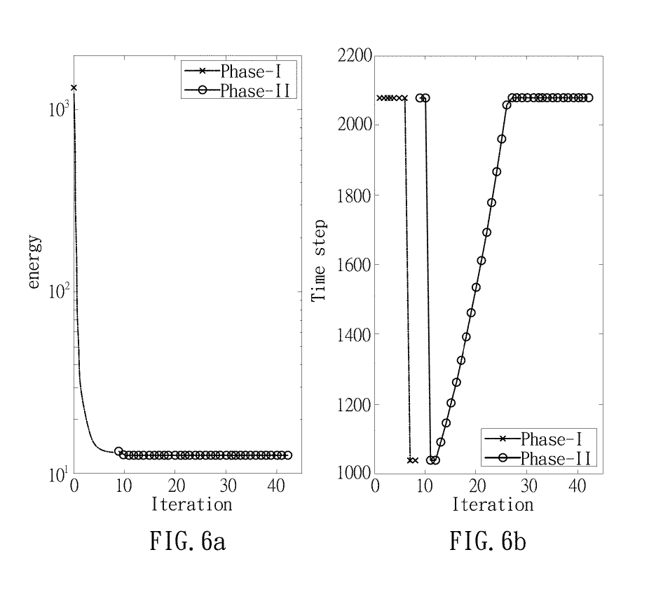

The high performance of Algorithm 1 in computing Riemann mapping has been numerically illustrated. In this subsection, the importance of phase-I QIEM in computing spherical conformal mapping is demonstrated and then the performance for Algorithm 1 in solving the benchmark problems in FIG. 2 is shown.
Effect of phase-I QIEM: Compare the efficiency of the phase-II QIEM with Algorithm 1 for solving (10) with genus zero closed surface in FIG. 2(c). The numerical results produced by Algorithm 1 are shown in FIG. 6. Since the initial map f⁽⁰⁾ is far away from the steady state solution, in numerical experiences, it is difficult to find an initial time step such that the phase-II QIEM can be convergent. The stability region of the time step in the phase-II QIEM for computing spherical conformal mapping is extremely limited. On the contrary, Algorithm 1 with initial time step δt₀.=2077.71 only requires 41 iterations which obviously outperforms phase-II QIEM. That is the phase-I QIEM in Algorithm 1 plays an important role in computing spherical conformal mapping.

TABLE 5
Numerical results for the benchmark
problems in FIG. 2 produced by Algorithm 1

| FIG. | #it_{I} | #it_{II} | t_{c} (sec.) |
|---|---|---|---|
| 2(a) | 16 | 42 | 145.7 |
| 2(b) | 8 | 121 | 234.6 |
| 2(c) | 8 | 33 | 31.03 |
| 2(d) | 5 | 80 | 6.117 |

Performance of Algorithm 1: the high performance computing for Algorithm 1 in computing spherical conformal mapping for the benchmark problems in FIG. 2 is demonstrated. The numerical results are shown in Table 5. The notations #it_{I} and #it_{II} denote the total iteration numbers for phase-I and phase-II QIEMs, respectively. From the results in this table, it is concluded that Algorithm 1 possesses high performance for computing the spherical conformal maps of genus zero closed surfaces.

In summary, a mapping is conformal if and only if it is harmonic for genus zero closed surfaces. A traditional way to find the harmonic map is to minimize the harmonic energy by the time evolution according to the nonlinear heat diffusion (10). For this, an efficient quasi-implicit Euler method (QIEM) is proposed and applied it to compute conformal mappings from a genus zero closed surface to the unit sphere [symbol] ² (the spherical conformal mapping) as well as from a simply connected surface with a single boundary to a 2D disk D (the Riemann mapping). Furthermore, the convergence of the QIEM under some simplifications is analyzed. In order to accelerate the convergence of this method, a variant time step scheme and a heuristic method to determine an initial time step have been developed. Numerical results validate that the proposed algorithms possess high performance for computing the Riemann mapping. For the spherical conformal map, a two-phase QIEM is proposed. In phase I QIEM, the normal component of Δ_{d}f is omitted to accelerate the computed map close to the steady state solution as soon as possible. When the computed map is close to the steady state solution in phase-I QIEM, it is switched to the adaptive time step controlling phase-II QIEM. Numerical results confirm that the two-phase QIEM also possesses high performance for computing the spherical conformal map.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for computing spherical conformal and Riemann mappings comprising the steps of:
(a) carrying out evolution of computing a conthnnal map f from a genus zero closed surface to a unit sphere as well as from a simply connected surface with a single boundary to a 2D disk by a nonlinear heat diffusion equation;
(b) solving the nonlinear heat diffusion equation by a quasi-implicit Euler method (QIEM);
(c) analyzing convergence of the QIEM under some simplifications;
(d) accelerating the convergence of the QIEM by using a two-phase approach for the quasi-implicit Euler method to estimate an initial time step and an adaptive method to control the time step.

2. The method as claimed in claim 1, wherein a way to find the conformal map f is by time evolution according to the nonlinear heat diffusion equation in the step (a)
$$\frac{df}{dt} = - {Δ}_{d} f . ;$$
the time evolution of the conformal map f is according to the nonlinear heat diffusion equation
$$\frac{df ( v )}{dt} = - {( {Δ}_{d} f ( v ) )}^{‖} = - ( {Δ}_{d} f ( v ) - < {Δ}_{d} f ( v ) , n ( f ( v ) ) > n ( f ( v ) ) ) .$$

3. The method as claimed in claim 1, wherein the Quasi-Implicit Euler Method (QIEM) in the step (b) is iteratively formulated by
$$\begin{matrix}\frac{{f}^{( m + 1 )} - {f}^{( m )}}{δ t} = - ( {Δ}_{d} {f}^{( m + 1 )} - ≺ {Δ}_{d} {f}^{( m )} , {f}^{( m )} ≻ {f}^{( m + 1 )} ) \\ = - ( A - ≺ A {f}^{( m )} , {f}^{( m )} ≻ ) {f}^{( m + 1 )} ,\end{matrix}$$
wherein an unknown vector f^{(m+1)} of F(f^{(m+1)}, f^{(m)} ) is solved by Newton's method
vec(fᵢ₊₁^{(m+1)})=vec(fᵢ^{(m+1)})−J(fᵢ^{(m+1)})⁻¹ F(fᵢ^{(m+1)}, f^{(m)})
with f₀^{(m+1)}=f^{(m)}, wherein J(f^{(m+1)}) is the Jacobian matrix of F(f^{(m+1)}, f^{(m)});
wherein a new vector f^{(m+1)} is generated in each iteration by solving a linear system
[I+δt(A− [symbol] Af^{(m)}, f^{(m)} [symbol] )]f^{(m+1)}=f^{(m)}.

4. The method as claimed in claim 1, wherein the two-phase approach for the quasi-implicit Euler method in the step (d) includes a phase-I QIEM formulated by
$$\frac{\vert {f}^{( m + 1 )} - {f}^{( m )}}{δ t} = - {Δ}_{d} {f}^{( m + 1 )} = - A {f}^{( m + 1 )} ,$$
if f⁽⁰⁾ is not close to the steady state solution;
i.e., (I+(δt)A)f^{(m+1)}=f^{(m)}
is used to compute f^{(m+1)}; and
a phase-II QIEM when f^{(m)} is close to the steady state solution, switch to [I+δt(A− [symbol] Af^{(m)}, f^{(m)} [symbol] )]f^{(m+1)}=f^{(m)}. with repetitive strategies (S₂.a), (S₂.b) and (S₂.c) fir computing f^{(m+1)} until difference |εₕ(f^{(m+1)})−εₕ(f^{(m)})| of energy is less than a given tolerance ε₃;
wherein (S₁.a) By definition of A in
$${a}_{ii} := {\sum }_{[ {v}_{i} , {v}_{j} ] ∈ M} {k}_{ij} , {a}_{ij} := - {k}_{ij} , i \neq j , ,$$
row sums of A are equal to zero which implies that there is a trivial solution f such that (A− [symbol] Af, f [symbol] )f=0 and εₕ(f)=0; to avoid f^{(m)} convergent to this trivial solution, reset δt₀ to be the current δt and restart algorithm with the original f⁽⁰⁾ and new δt₀ when εₕ(f^{(m)}) is less than a given small tolerance ε₂;
(S₁.b) If εₕ(f^{(m+1)}) does not decrease, then δt is reduced to be δt:=max(1, 1/2 δt) and recompute f^{(m+1)} from the [I+δt(A− [symbol] Af^{(m)}, f^{(m)} [symbol] )]f^{(m+1)}=f^{(m)};
(S₁.c) If the difference of the energy is still larger than or equal to the given tolerance ε₃ when m has been larger than a given maximal iteration number mₘₐₓ, reset δt₀ to be the current δt and restart the algorithm with original initial closed surface f⁽⁰⁾ and new δt₀.
